(19) United States
(12) Patent Application Publication
(10) Pub. No.: US 2009/0059161 A1
(43) Pub. Date: Mar. 5, 2009

(54) Ear shield

(76) Inventors: Gary Fernandes, Woonsocket, RI (US); Jean Colardo, Johnston, RI (US)

Correspondence Address: JAMES RAY & ASSOCIATES, 2640 PITCAIRN ROAD, MONROEVILLE, PA, 15146, US

(21) Appl. No.: 12/231,208

(22) Filed: Aug. 29, 2008

Related U.S. Application Data
(60) Provisional application No. 60/966,924, filed on Aug. 30, 2007.

(51) Int. Cl. G02C 11/00

(52) U.S. Cl. 351/158

(57) ABSTRACT

An apparatus for providing a protective covering for ears when riding a motorcycle. The apparatus comprises a disc shaped member for covering an ear of a user, such disc shaped member being formed of a first predetermined material for engagement with an arm of a pair of glasses worn by a one of a motorcycle rider and a bicycle rider; and a means attached to a predetermined portion of such disc shaped member for securing such disc shaped member to the arm of such glasses.

### CROSS REFERENCE TO RELATED APPLICATIONS

This application is closely related to and claims benefit from U.S. Provisional Application Ser. No. 60/966,924 filed Aug. 30, 2007.

### FIELD OF THE INVENTION

The present invention relates, in general, to an ear shield, and, more particularly, the present invention relates to an ear protector that is made to attach to the side of glasses worn when riding a motorcycle so as to provide protection for the ears and prevent damage to the ears due to wind.

### BACKGROUND OF THE INVENTION

Many motorcycle enthusiasts ride long distances without a covering for the ears. Once the riders come to a stop, they notice that the ears ring or feel stuffed, which can make hearing difficult. Without the ability to clearly recognize sounds within the immediate area, a rider can put himself in harm's way. Talking with other riders while at a stop light or when the days travels are over can also prove to be bothersome after spending time on the open road with wind howling against the ears. Unprotected ears are also prone to wind and sun exposure, which can burn ears and cause additional discomfort.

Thus, it would be advantageous if there were a simple and effective means of protecting the ears while riding on a motorcycle.

### SUMMARY OF THE INVENTION

In a first aspect the present invention provides an apparatus for providing a protective covering for ears when riding a motorcycle. The apparatus comprises a disc shaped member for covering an ear of a user, such disc shaped member being formed of a first predetermined material for engagement with an arm of a pair of glasses worn by a one of a motorcycle rider and a bicycle rider; and a means attached to a predetermined portion of such disc shaped member for securing such disc shaped member to the arm of such glasses.

### OBJECTS OF THE INVENTION

It is, therefore, one of the primary objects of the present invention to provide an apparatus to prevent a wind damage to motorcycle riders.

Another object of the present invention is to provide an apparatus to protect the ears that is attached to a pair of glasses.

Still another object of the present invention is to provide an apparatus for protecting the ears that will also provide a significant reduction in the noise.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front perspective view of the apparatus according to an embodiment of the invention showing a pair of ear protectors.

FIG. 2 is a is a side perspective view of the apparatus shown in FIG. 1 attached to the arms of a pair of glasses.

FIG. 3 is a back perspective view of the apparatus shown in FIG. 1 showing the inside of such ear protector.

FIG. 4 is a front perspective view of the apparatus shown in FIG. 1 showing a hook and loop means of securing the ear protector to a pair of glasses.

FIG. 5 is a front perspective view of the apparatus shown in FIG. 1 showing a clip means of securing the ear protector to a pair of glasses.

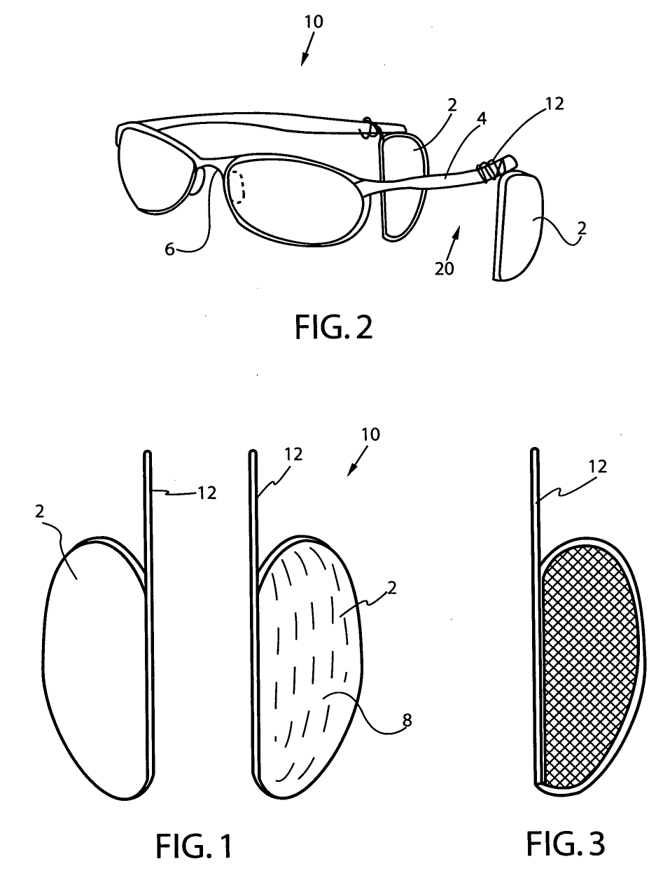

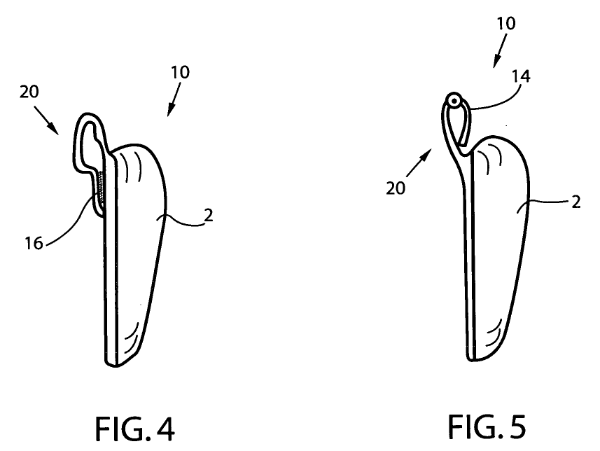

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing a protective covering for ears when riding a motorcycle. The apparatus 10 comprises a disc shaped member 2 for covering an ear of a user, such disc shaped member 2 being formed of a first predetermined material for engagement with an arm 4 of a pair of glasses 6 worn by a one of a motorcycle rider and a bicycle rider; and a means 20 attached to a predetermined portion of such disc shaped member 2 for securing such disc shaped member 2 to the arm 4 of such glasses 6.

It is presently preferred that such apparatus 10 further includes an outer covering 8 formed of a second predetermined material disposed around such disc shaped member 2 for providing additional comfort to such user.

Such means 20 for securing the disc shaped member 2 to such arm 4 of such glasses 6 includes a third predetermined material disposed on an upper portion of the disc shaped member 2. Such third predetermined material is selected from the group comprising a metallic wire 12, a clip 14 and a hook and loop fastener 18. Such metallic wire 12 is wound around such arm 4 of such glasses 6 thereby securing the disc shaped member 2 to such glasses 6.

It is also presently preferred that such first predetermined material is plastic and that such second predetermined material is a rubber material.

It is also within the scope of the invention that such disc shaped member has an oval shape so as to conform to a shape of a person's ear.

Thus, the present invention provides a protective ear covering designed for attachment to a pair of glasses. The product is made specifically for use by motorcycle riders to prevent damage to the ears due to wind exposure. Other sports enthusiasts and thrill seekers who partake in extreme sports of various types, bicycling, boating and an array of other activities can also use the ear protector. The unit is comprised of a disc shaped member made of plastic with a means for securing it to an arm of a pair of glasses. One such means includes a wire member attached to the top of the ear shield which can be wound around the arm of such glasses to secure it in place and then position the ear shield over the ear for protection. Such ear shield has an outer cover made of a rubberized material for additional comfort. It should also be noted that such ear shield while protecting the ears from wind damage will also significantly reduce the noise in the environment which around motorcycles is generally loud.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for providing a protective covering for ears when riding a motorcycle, said apparatus comprising:
(a) a disc shaped member for covering an ear of a user, said disc shaped member being formed of a first predetermined material for engagement with an arm of a pair of glasses worn by a one of a motorcycle rider and a bicycle rider; and
(b) a means attached to a predetermined portion of said disc shaped member for securing said disc shaped member to such arm of such glasses.

2. The apparatus, according to claim 1, wherein said apparatus further includes an outer covering formed of a second predetermined material disposed around said disc shaped member for providing additional comfort to such user.

3. The apparatus, according to claim 1, wherein said means for securing said disc shaped member to such arm of such glasses includes a third predetermined material disposed on an upper portion of said disc shaped member.

4. The apparatus, according to claim 3, said third predetermined material is selected from the group comprising a metallic wire, a clip and a hook and loop fastener.

5. The apparatus, according to claim 4, wherein said metallic wire is wound around such arm of such glasses thereby securing said disc shaped member to such glasses.

6. The apparatus, according to claim 1, wherein said first predetermined material is plastic.

7. The apparatus, according to claim 2, wherein said second predetermined material is a rubber material.

8. The apparatus, according to claim 1, wherein said disc shaped member further has an oval shape so as to conform to a shape of a person's ear.
